(19) United States
(12) Patent Application Publication
(10) Pub. No.: US 2026/0230753 A1
(43) Pub. Date: Aug. 6, 2026

(54) AUDIO EQUIPMENT

(71) Applicant: Audio-Technica Corporation, Tokyo (JP)

(72) Inventors: Kouhei YOSHIDA, Tokyo (JP); Akihito TAMAMURA, Tokyo (JP)

(21) Appl. No.: 19/149,628

(22) PCT Filed: Jan. 11, 2024
(86) PCT No.: PCT/JP2024/000358

§ 371 Date: Jul. 21, 2025

(30) Foreign Application Priority Data
Jan. 31, 2023 (JP) 2023-012574

(51) Int. Cl. H04R 5/033; H04R 11/02

(52) U.S. Cl. CPC H04R 5/0335; H04R 11/02; H04R 2460/13

(57) ABSTRACT

A configuration for generating bone conduction vibration is provided, and high sound quality is ensured by achieving a secure fit to a head regardless of individual differences.

Audio equipment 1000 includes: an electroacoustic transducer 1 that generates vibration to be transmitted to a bone of a wearer; a housing 2 that houses the electroacoustic transducer; and an elastic member 2b disposed at least on an outer surface 2a of the housing that faces the wearer in a worn state.

### TECHNICAL FIELD

The present invention relates to audio equipment that performs bone conduction.

### BACKGROUND ART

There are known an output device that allows a user to hear a sound by contact between an outer wall surface and a skull, and a sound output device that allows a user to hear an air conduction sound via cartilage conduction generated in an ear canal from an ear canal surface of a cartilage portion by contact with a bone such as an ear cartilage around an entrance portion of the ear canal.

There has been known a cartilage conduction vibration source device for a mobile phone or the like, for example, which performs acoustic processing on a sound signal for cartilage conduction vibration and outputs a processing signal as a drive signal to a cartilage conduction vibration source (see, for example, Patent Literature 1). In addition, a stereo earphone including a cartilage conduction portion and a branch portion having one end connected to the cartilage conduction portion and serving as a vibration source is disclosed (see, for example, Patent Literature 2).

A sound output device using bone conduction includes a vibration portion that vibrates according to a sound signal. In this case, the sound output device may not fit a head of a wearer depending on a shape of the head of the wearer or the like, and vibration of the vibration portion may not be transmitted to a bone. As a result, a volume audible to the wearer may be significantly reduced. However, none of the literatures discloses a technique for ensuring high sound quality by achieving a secure fit to a head regardless of individual differences in a sound output device using bone conduction.

### CITATION LIST

### Patent Literature

Patent Literature 1: JP 2013-197730 A

Patent Literature 2: JP 2014-116755 A

### SUMMARY OF INVENTION

### Technical Problem

An object of the present invention is to provide audio equipment that ensures high sound quality by achieving a secure fit to a head regardless of individual differences.

### Solution to Problem

Audio equipment according to the present invention includes: an electroacoustic transducer that generates vibration to be transmitted to a bone of a wearer; a housing that houses the electroacoustic transducer; and an elastic member disposed at least on an outer surface of the housing that faces the wearer in a worn state.

### Advantageous Effects of Invention

According to the present invention, it is possible to provide audio equipment that ensures high sound quality by achieving a secure fit to a head regardless of individual differences.

### BRIEF DESCRIPTION OF DRAWINGS

FIG. 1 is a schematic perspective view illustrating an embodiment of a headphone which is an example of audio equipment according to the present invention.

FIG. 2 is a schematic partially enlarged perspective view illustrating a state of a housing of the headphone.

FIG. 3 is a graph illustrating a frequency characteristic of the headphone and a frequency characteristic of a first related art.

FIG. 4 illustrates a perspective view (a) of a first embodiment of headphone unit according to the present invention when viewed from a front side, and a perspective view (b) of the first embodiment of the headphone unit when viewed from a rear side.

FIG. 5 is an exploded perspective view of the headphone unit.

FIG. 6 is a longitudinal sectional view of the headphone unit.

FIG. 7 is a one-side cross-sectional view illustrating a vibration portion included in the headphone unit.

FIG. 8 is a graph illustrating a frequency characteristic of the headphone unit and a frequency characteristic of a related art.

FIG. 9 is a one-side cross-sectional view illustrating a second embodiment of the headphone unit according to the present invention.

FIG. 10 is a longitudinal sectional view of a headphone unit according to a second related art.

FIG. 11 is a schematic perspective view illustrating a second embodiment of the audio equipment according to the present invention.

### DESCRIPTION OF EMBODIMENTS

Hereinafter, embodiments of audio equipment according to the present invention will be described with reference to the drawings. In the following description, an axial direction of an electroacoustic transducer 1 is also referred to as a y direction, and directions orthogonal to the y direction are also referred to as an x direction and a z direction. A surface facing a +z direction is also referred to as an upper surface, and a surface facing a −z direction is also referred to as a bottom surface. Further, a surface facing a −y direction is also referred to as a front surface, and a surface facing a +y direction is also referred to as a rear surface.

### Headphone

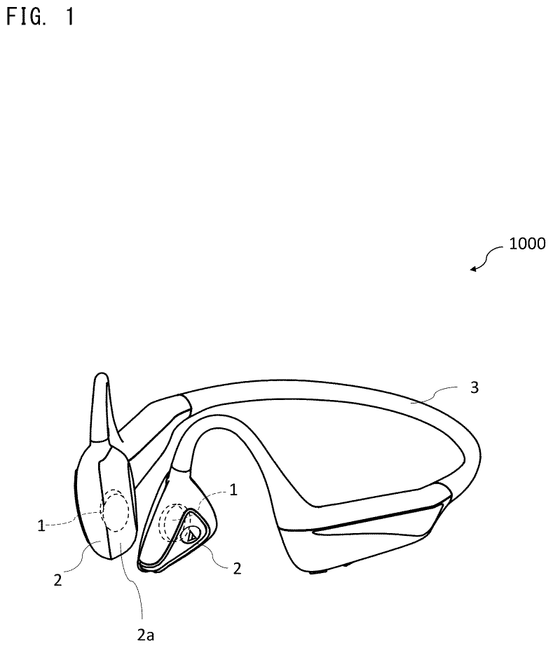

A headphone 1000 as an example of the audio equipment will be described with reference to FIG. 1. As illustrated in FIG. 1, the headphone 1000 mainly includes a pair of electroacoustic transducers 1, a pair of housings 2, and a headband 3. Each of the pair of housings 2 has a substantially triangular prism shape, and incorporates the electroacoustic transducer 1 therein. A shape of the housing 2 is arbitrary, and may be a substantially rectangular parallelepiped shape.

The headband 3 is a substantially U-shaped member. Both end portions of the headband 3 are each curved in a direction substantially orthogonal to a U-shaped portion and are put on ears of a wearer in a worn state. The housing 2 is coupled to each of both end portions of the headband 3. That is, the electroacoustic transducer 1 is held at each of both end portions of the headband 3 via the housing 2. The headband 3 sandwiches a head of the wearer in the worn state, and an outer surface 2a of the housing 2 that faces the wearer is pressed against the vicinity of the ear by an elastic force of the headband 3. The headband 3 is an example of a housing holding portion in the claims.

In the present embodiment, a configuration in which the electroacoustic transducer mainly transmits vibration to an ear cartilage (also referred to as tragus cartilage or auricular cartilage) will be described, but the technical scope of the present invention is not limited thereto and includes the headphone and the electroacoustic transducer that transmit vibration to any bone including a cartilage tissue other than the ear cartilage and a hard bone tissue such as a skull. That is, the bone in the claims is a concept including any one or both of the cartilage tissue and the hard bone tissue.

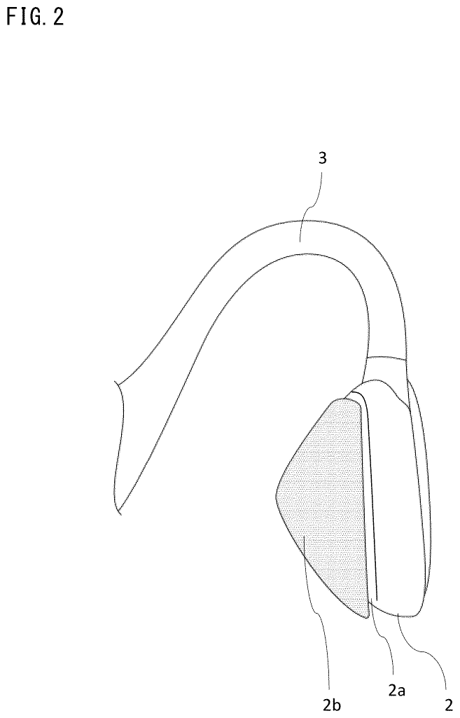

As illustrated in FIG. 2, an elastic member 2b is disposed on the outer surface 2a of the housing 2 that faces the wearer in the worn state. The outer surfaces 2a are surfaces of the pair of housings 2 substantially facing each other.

The elastic member 2b is interposed between the housing 2 and the head of the wearer in the worn state and is pressed against the head. More specifically, the elastic member 2b is a member pressed against the ear cartilage or the skull. The elastic member 2b comes into close contact with irregularities of a body shape of the wearer without any gap.

The elastic member 2b is disposed on the entire outer surface 2a in the figure, and may be disposed on at least a part of the outer surface 2a or may extend from the outer surface 2a. Furthermore, the elastic member 2b has a substantially triangular shape similar to that of the outer surface 2a in the figure, but the shape of the elastic member 2b is arbitrary. The elastic member 2b may be disposed at a portion other than the outer surface 2a, and, for example, may be disposed so as to form a ring shape along an outer periphery of the housing 2 or may be disposed on the entire outer periphery. In a case where an appropriate operator is disposed in the housing 2, it is preferable that the elastic member 2b is provided avoiding the operator.

The elastic member 2b is detachably disposed on the housing 2. The elastic member 2b is bonded to the housing 2 with, for example, a weak double-sided tape so as to be detachable. In addition, the elastic member has a bag shape and may have a shape covering the housing 2. The elastic member has a ring shape and may cover the outer periphery of the housing 2. In this case, the elastic member is in close contact with the outer periphery of the housing 2 by the elastic force thereof. The housing 2 may have a structure in which the elastic member is fitted. In this case, specifically, for example, the housing 2 and a soft material are integrally molded by insert molding or the like, and the elastic member is fitted to the soft material. Further, the elastic member 2b and the housing 2 may include hook-and-loop fasteners fitted to each other. According to such a configuration, the wearer can easily replace the elastic member 2b. That is, it is possible to easily replace the elastic member 2b in a case where the elastic member 2b deteriorates over time In addition, the wearer can select the elastic member from among a plurality of types according to preference of a feeling of use, sound quality, and the like.

The elastic member 2b may be, for example, a member such as sponge, urethane foam, or rubber sponge, or may be an appropriate member having an elastic force. The elastic member 2b may be a member having a relatively low coefficient of restitution, and may be, for example, a so-called low-rebound sponge such as low-rebound urethane foam. In addition, the elastic member 2b is not limited to a member having elasticity due to the nature of a material itself of the member, and may be a member having elasticity due to a mechanical shape. That is, the elastic member 2b may be, for example, a member such as a coil spring, a leaf spring, or a spiral spring. In addition, the elastic member 2b may be a single member or may be implemented by a plurality of members.

The elastic member 2b provides a softer tactile sensation than the housing 2. Therefore, according to a configuration in which the elastic member 2b abuts on the head, wearing feeling of the wearer is improved. In addition, in the worn state, the elastic member 2b is pressed and elastically deformed and comes into close contact with the body shape of the wearer, here, the irregularities of the head without any gap, so that adhesion to the head is improved. Furthermore, according to a configuration in which the housing 2 comes into close contact with the head, it is possible to prevent the headphone 1000 from being displaced from the head.

In particular, the ear cartilage has a more solid shape compared to a relatively flat skull. In addition, a shape of the ear cartilage varies greatly among individuals. Therefore, in a configuration in which the relatively hard housing 2 is directly pressed against the ear cartilage, there is a possibility that a pressure is intensively applied to a portion on which the housing 2 abuts. On the other hand, according to a configuration including the elastic member 2b, the housing 2 can be uniformly fitted to the ear cartilage having a solid shape that varies greatly among individuals. As a result, with this configuration, in a cartilage conduction headphone that transmits vibration to the ear cartilage, it is possible to reduce variations in vibration transmission efficiency among individuals.

That is, as described above, it is preferable that the elastic member 2b is thin enough to sufficiently transmit a sound to the wearer, and has a thickness enough to come into close contact with the irregularities of the body shape without any gap.

### Frequency Characteristic of Headphone 1000

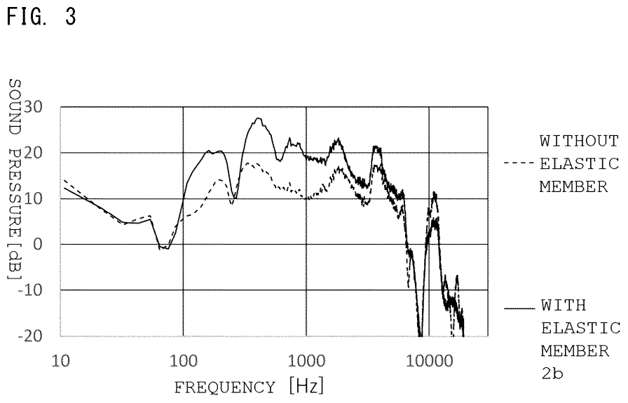

FIG. 3 is a graph illustrating an example of a frequency characteristic of the headphone 1000 in which the elastic member 2b is disposed. That is, a horizontal axis represents a frequency, and a vertical axis represents an output level (dBV). FIG. 3 illustrates a result of measuring a sound pressure by mounting the headphone 1000 on a silicon artificial ear in a state in which an ear simulator compliant with IEC 60318-4 is put in the artificial ear. A solid line indicates the frequency characteristic of the headphone 1000 according to the present invention. A broken line indicates a frequency characteristic of a headphone according to a related art in which only the elastic member 2b is omitted and the other configurations are similar.

In the figure, it is apparent that the headphone 1000 with the elastic member 2b achieves a higher sound pressure particularly in an audible frequency range. The reason why the headphone 1000 with the elastic member 2b achieves a high sound pressure is considered to be that the adhesion to the cartilage by the elastic member 2b is improved, and the elastic member 2b converts some vibration into a sound, and the sound reaches an eardrum as an air conduction sound to complement the sound pressure.

In the headphone that transmits vibration to a bone including a cartilage and a hard bone, the vibration of the electroacoustic transducer 1 needs to be transmitted the bone via the housing 2. However, the outer surface of the housing 2 may not sufficiently come into contact with the bone of the wearer depending on the shape of the head of the wearer and the shape of the housing 2 or the headband 3. As a result, the vibration of the vibration portion cannot be transmitted to the bone, and a volume audible to the wearer may be significantly reduced. However, in the case of increasing the volume to be output in advance, low-frequency vibration may cause discomfort to the wearer. In addition, in a case where the volume is to be electrically increased, it is highly probable that current consumption becomes insufficient with a small battery mounted on a conventional headphone suitable for a wearable device. On the other hand, in a case where a low-frequency volume is lowered by equalizer adjustment or the like, the sound quality in normal use is not powerful and insufficient. In addition, it is conceivable to perform adjustment to change the sound quality depending on the volume, but since sensitivity of the ear cartilage greatly varies among individuals, it is difficult to achieve appropriate sound quality for a large number of wearers.

On the other hand, in the headphone 1000 according to the present invention, as described above, the housing 2 can come into close contact with the ear cartilage having a solid shape that greatly varies among individuals via the elastic member 2b. In addition, as illustrated in FIG. 3, the headphone 1000 can achieve a high sound pressure in the audible frequency range.

The audio equipment according to the present invention is not limited to the headphone 1000 described above, and includes various types of equipment that are worn by the wearer and transmit a sound to the wearer. The audio equipment according to the present invention only needs to have a structure in which the vibration portion is brought into contact with a tissue near the ear with an appropriate side pressure, and a specific configuration of the housing holding portion that holds the housing including the vibration portion is not limited to the headband. That is, the housing holding portion may be, for example, a neck band worn around a neck or a chin band worn along a jaw. In addition, the audio equipment may be so-called headband type audio equipment in which the housing is integrally housed in the housing holding portion.

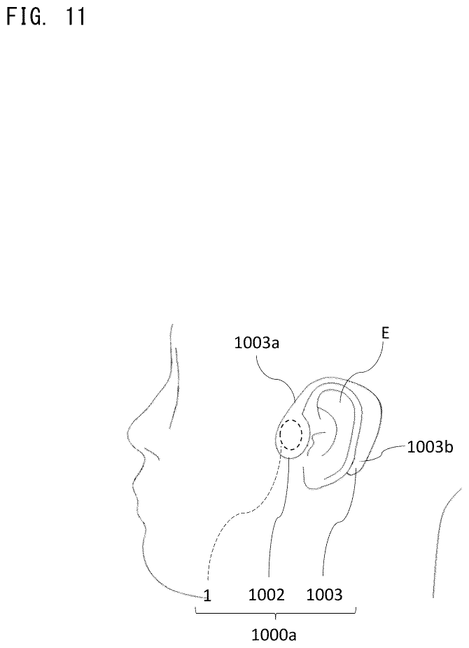

FIG. 11 is a schematic perspective view illustrating a second embodiment of the acoustic equipment according to the present invention. Audio equipment 1000a mainly includes an electroacoustic transducer 1, a housing 1002 that houses the electroacoustic transducer 1, and a housing holding portion 1003 that holds the housing 1002. The housing 1002 in the present embodiment has a flat columnar shape. The housing holding portion 1003 is, for example, a U-shaped member, and a first end 1003a and a second end 1003b face each other with a gap therebetween. The housing 1002 is disposed at the first end 1003a of the housing holding portion 1003. In a worn state, the housing holding portion 1003 sandwiches an auricle E of a wearer in the gap between the first end 1003a and the second end 1003b. As a result, the housing holding portion 1003 uses a drag from the auricle E to press an elastic member against the wearer and apply a side pressure to a vibration portion. According to such a configuration, a band around a head is unnecessary, and thus, the configuration is simple. Furthermore, according to such a configuration, audio equipment for one ear can be implemented.

### Electroacoustic Transducer (1)

A first embodiment of the electroacoustic transducer of the present embodiment will be described.

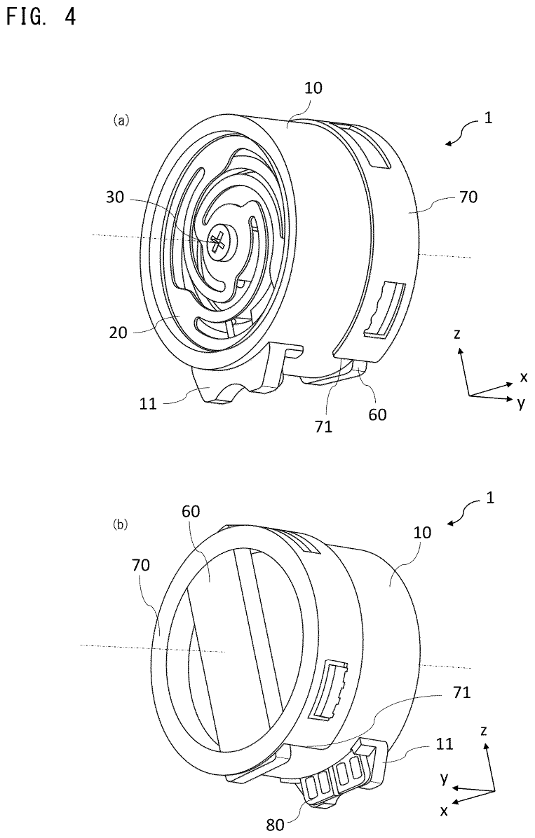

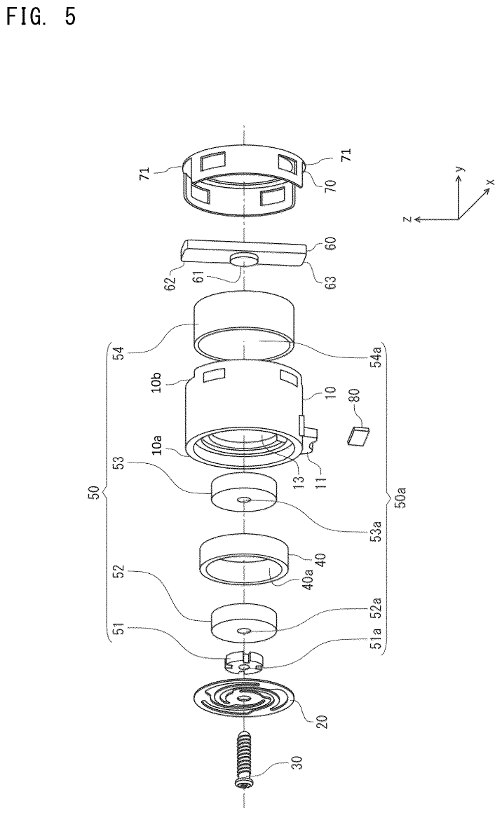

As illustrated in FIGS. 4 (a) and 4 (b), the electroacoustic transducer 1 is a substantially columnar member, and is a member worn on each of left and right ears in a pair. A main frame 10, a suspension 20, a screw 30, a coil 40, a damper 60, a damper fixing ring 70, and a substrate 80 are mainly provided on an outer peripheral surface of the electroacoustic transducer 1. Furthermore, as illustrated in FIG. 5, a vibration portion 50 that vibrates in a predetermined vibration direction according to a signal is disposed inside the electroacoustic transducer 1.

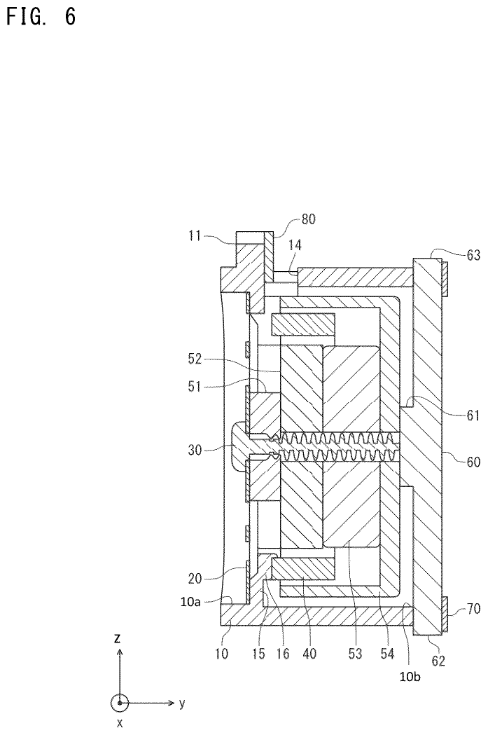

As illustrated in FIG. 5, the main frame 10 is a cylindrical member that defines an outer wall of the electroacoustic transducer 1, and has a through-hole 13 penetrating in the axial direction (y direction). A substrate holding portion 11 and a hole 14 (see FIG. 6) are formed in an outer wall of the main frame 10. The substrate holding portion 11 is a flat-plate-like member protruding from the outer wall of the main frame 10. The substrate 80 is held by the substrate holding portion 11. The hole 14 is formed at a coupling portion between the substrate holding portion 11 and the main frame 10. An appropriate cable connecting the coil 40 and the substrate 80 is inserted into the hole 14.

As illustrated in FIG. 6, a flange portion 15 protrudes inward on a side of a first end 10a of the through-hole 13. The flange portion 15 is formed over substantially the entire periphery of an inner wall. The suspension 20 abuts on a front side (−y side) of the flange portion 15. Further, a second flange portion 16 further protruding inward in a radial direction is formed over the entire periphery of a distal end portion of the flange portion 15, and the coil 40 is held on a rear side (+y side) of the second flange portion 16.

The suspension 20 is a disk-shaped member disposed on a front side of the electroacoustic transducer 1. The suspension 20 is a first member in the present embodiment. The suspension 20 is a member having an elastic force, such as a leaf spring, and holds the vibration portion 50 in the main frame 10. The suspension 20 also has a function of controlling the vibration of the vibration portion 50. The suspension 20 is held on the side of the first end 10a of the main frame 10. More specifically, the suspension 20 abuts on the flange portion 15 formed on the inner wall of the through-hole 13. In addition, the suspension 20 abuts on a front surface of the vibration portion 50. More specifically, the suspension 20 abuts on a front end portion (a first end of the vibration portion 50 in the present embodiment) of a spacer 51 of the vibration portion 50 described below. As a result, a contact point between the main frame 10 and the suspension 20 serves as a fulcrum of the vibration of the vibration portion 50.

The screw 30 is a member inserted from the-y direction toward the ty direction. The screw 30 is inserted into each of a through-hole 21 formed at a central portion of the suspension 20 and a through-hole 50a of the vibration portion 50. The through-hole 21 of the suspension 20 is first through-hole in the present embodiment. The through-hole 50a of the vibration portion 50 is a second through-hole in the present embodiment.

The coil 40 is an annular member and is held on the inner wall of the through-hole 13 of the main frame 10. In the present embodiment, the coil 40 is held inside the main frame 10 by abutting on the second flange portion 16. A plate yoke 52 and a magnet 53 included in the vibration portion 50 are inserted into a hole 40a formed at a central portion of the coil 40.

The vibration portion 50 is a member disposed inside the through-hole 13 of the main frame 10. The vibration portion 50 vibrates inside the through-hole 13 in an axial direction of the through-hole 13.

As illustrated in FIGS. 5 and 6, the vibration portion 50 is mainly implemented by arranging the spacer 51, the plate yoke 52, the magnet 53, and a cap yoke 54 in this order.

The spacer 51 is positioned on the most front side of the vibration portion 50. The spacer 51 is a substantially columnar member. The front end portion of the spacer 51 is the first end of the vibration portion 50 in the present embodiment. Both ends of the spacer 51 abut on the suspension 20 and the plate yoke 52, respectively. A through-hole 51a penetrating in the axial direction is formed at a central portion of the spacer 51. The screw 30 is inserted into the through-hole 51a. A plurality of recesses 51b are formed on an outer surface of the spacer 51. In the present embodiment, a total of four recesses 51b are provided at positions where straight lines of the center of the spacer 51 and the recess 51b are orthogonal to each other.

The plate yoke 52 is a substantially columnar member. A through-hole 52a penetrating in the axial direction is formed at a central portion of the plate yoke 52. The magnet 53 is a substantially columnar magnet, and a through-hole 53a penetrating in the axial direction is formed at a central portion of the magnet 53. Outer diameters of the plate yoke 52 and the magnet 53 are smaller than that Of an inner circumference of the hole 40a of the coil 40. Accordingly, the plate yoke 52 and the magnet 53 are movable in the axial direction (y direction) inside the hole 40a. A Lorentz force is generated in the magnet 53 and the coil 40. As a result, the vibration portion 50 vibrates in the axial direction.

The cap yoke 54 forms the outermost shell including the rearmost surface of the vibration portion 50. The cap yoke 54 is a bottomed cylindrical member opened to the front side. A rear surface of the cap yoke 54 is a second end of the vibration portion 50 in the present embodiment. An outer surface of the cap yoke 54 covers at least a part of the plate yoke 52 and the magnet 53. An inner diameter of the cap yoke 54 is larger than an outer diameter of the coil 40. The outer surface of the cap yoke 54 is disposed outside the coil 40. A through-hole 54a penetrating in the axial direction is formed at a central portion of the cap yoke 54.

The through-hole 51a of the spacer 51, the through-hole 52a of the plate yoke 52, the through-hole 53a of the magnet 53, and the through-hole 54a of the cap yoke 54 are formed substantially coaxially to form the through-hole 50a of the vibration portion 50. The screw 30 is inserted into the through-hole 50a.

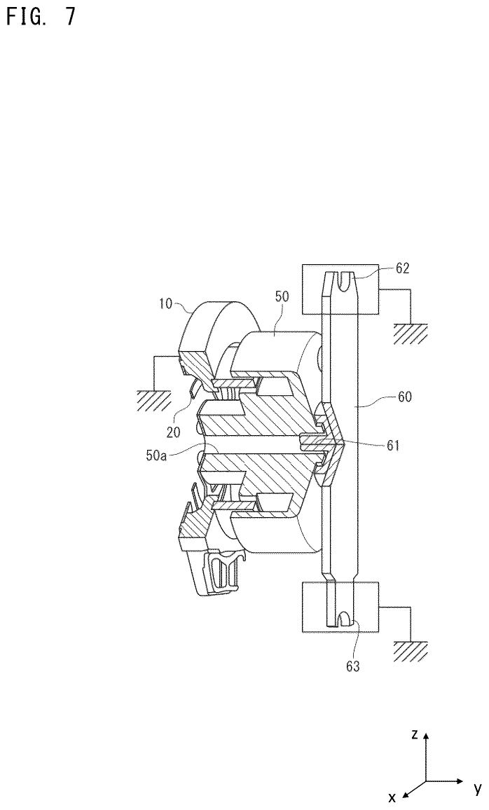

The damper 60 is a member that abuts on a second end 10b of the main frame 10 and the vibration portion 50. The damper 60 is a member having an elastic force, and is made of, for example, rubber. The damper 60 may be made of sponge or gel. A protrusion 61 protruding in a substantially columnar shape is formed at a front central portion of the damper 60. As illustrated in FIG. 7, the protrusion 61 is inserted into the through-hole 50a of the vibration portion 50 and is coupled to the vibration portion 50. As a result, the vibration of the vibration portion 50 is transmitted to the damper 60 via the protrusion 61.

As described above, the vibration direction in which the vibration portion 50 vibrates according to the signal is the y direction, and is different from a vertical direction in the worn state. Therefore, the vibration portion 50 receives gravity in a direction different from the vibration direction. The damper 60 supports the vibration portion 50 by abutting on the main frame 10 and the vibration portion 50. That is, the damper 60 prevents the vibration portion 50 from hanging downward due to the gravity.

The damper 60 abuts on the second end 10b of the main frame 10 at least at two points. In the present embodiment, the damper 60 is an elongated flat plate, and each of short side portions 62 and 63 is coupled to a rib or the like formed at the second end 10b of the main frame 10. A long side of damper 60 extends in a substantially vertical direction in the worn. The elongated flat-plate-like damper 60 can prevent vibration of the vibration portion 50 in an unintended direction, for example, a direction of rotation on an x-z plane while securing a sufficient deflection margin. Further, according to a configuration in which the plate-like damper 60 spreads on a plane orthogonal to the vibration direction of the vibration portion 50, deformation in the vibration direction easily occurs, and deformation in a direction other than the vibration direction hardly occurs. Therefore, the damper 60 does not excessively attenuate the vibration of the vibration portion 50 in the vibration direction.

The short side portions 62 and 63 of the damper 60 and the second end 10b may be bonded to each other. A contact point between the damper 60 and the second end 10b is another fulcrum of the vibration.

A shape of the damper 60 is not limited to that in the present embodiment. For example, the damper 60 may have a circular shape, or may have a triangular shape or a polygonal shape with five or more sides. Furthermore, the damper 60 may be a so-called X-type in which rectangles orthogonal to each other are coupled. In this case, four points protruding from the center may be coupled to the main frame 10. Furthermore, although the damper 60 of the present embodiment has a plate shape, it is sufficient if the damper 60 suppresses displacement of the vibration portion 50 in a direction other than the vibration direction, and the damper 60 may be, for example, a coil spring.

The damper 60 has a predetermined hardness and coefficient of restitution. As a result, the damper 60 damps and eliminates abnormal oscillation at a resonance point of the vibration portion 50, and suppresses displacement of the vibration portion 50 in a direction different from the vibration direction. The damper 60 suppresses displacement of the vibration portion 50 in a rotation direction. The displacement of the vibration portion 50 in a direction other than the vibration direction in which the vibration portion 50 vibrates according to the signal causes abnormal noise. On the other hand, the damper 60 can suppress abnormal noise by preventing displacement in a direction other than the axial direction, and consequently can improve sound quality of the electroacoustic transducer 1. A characteristic such as the hardness or the coefficient of restitution of the damper 60 is appropriately adjusted according to desired sound quality, a mass or shape of the vibration portion 50, and the like.

The damper 60 with this configuration also functions as an adjustment member for the elastic force of the suspension 20. In this regard, a configuration in which the damper 60 is disposed on a rear side of the vibration portion 50 facilitates adjustment after assembly as compared with a configuration in which the damper is directly attached to the suspension 20 disposed on the front side of the vibration portion 50. In the case of being worn as the bone conduction headphone, the vibration from the vibration portion is transmitted to the main frame via the suspension and further transmitted to a bone portion via the housing 2 of the headphone. As compared with a case where the damper is directly attached to the suspension 20, this configuration does not attenuate a high-frequency vibration component and does not cause deterioration of sound quality.

The damper fixing ring 70 is a bottomed cylindrical member in which two portions facing each other on an outer peripheral surface are cut out. Such notch portions 71 correspond to positions of the short side portions 62 and 63 of the damper 60. The damper fixing ring 70 is coupled to the second end 10b of the main frame 10. More specifically, for example, the damper fixing ring 70 is fitted with the rib formed on a rear surface of the main frame 10. In an assembled state, the damper 60 is disposed in the notch portions 71 of the damper fixing ring 70. That is, the damper 60 is sandwiched between the damper fixing ring 70 and the main frame 10.

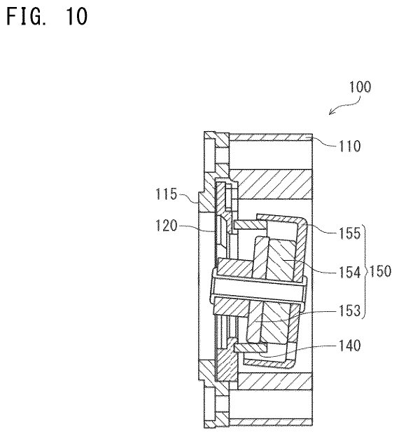

Here, an electroacoustic transducer 100 according to a related art will be described with reference to FIG. 10.

The electroacoustic transducer 100 according to the related art illustrated in FIG. 10 is a vibratory headphone unit that does not include a damper coupled to a vibration portion 150 and a main frame 110. The electroacoustic transducer 100 mainly includes the cylindrical main frame 110, a disk-shaped suspension 120, and the vibration portion 150 that vibrates inside the main frame 110.

The suspension 120 abuts on an inner side of a flange portion 115 formed on an inner wall of the main frame 110. A central portion of the vibration portion 150 is coupled to the center of the suspension 120 by a coupling member such as a screw. As a result, the vibration portion 150 is supported by the flange portion 115 via the suspension 120. Therefore, a fulcrum of the vibration of the vibration portion 150 is the coupling member, and a contact portion between the suspension 120 and the flange portion 115 serves as an action point. As described above, in the electroacoustic transducer 100 in which the center of gravity of the vibration portion 150 and the fulcrum of the vibration are separated from each other, there is a possibility that instability at a resonance point, that is, vibration in an unintended direction, occurs. The instability at the resonance point causes abnormal noise.

In addition, in FIG. 10, a vertical direction is a downward direction on the plane of the page. A vibration direction in which the vibration portion 150 vibrates according to a signal is different from the vertical direction in a worn state. Therefore, gravity is applied to the vibration portion 150 in a direction different from the vibration direction. A first end side of the vibration portion 150 is coupled to the suspension 120 at a substantially central portion, and a second end side of the vibration portion 150 is not supported and is in a cantilever state. Therefore, a second end of the vibration portion 150 hangs in a direction of gravity. As a result, the electroacoustic transducer 100 generates an unnecessary moment or twist at the time of resonance. The moment or twist is a cause of the instability or breakage.

Furthermore, a mass of the vibration portion 150 in the electroacoustic transducer 1 that transmits vibration to the ear cartilage is larger than that of a headphone unit that vibrates a diaphragm in order to vibrate the ear cartilage. Therefore, the downward hanging of the vibration portion 150 and the instability at the resonance point are further increased as compared with the headphone unit including the diaphragm. As a result, the downward hanging or instability causes a failure.

Furthermore, the vibration portion 150 the electroacoustic transducer 100 may vibrate due to vibration from the outside. In this case, when the vibration portion 150 vibrates, an electromotive force is generated in a coil 140 disposed so as to face the vibration portion 150. As a result, in the headphone unit including the vibration portion, there is a possibility that the vibration becomes abnormal noise and is mixed in a sound.

The mass of the vibration portion 50 of the electroacoustic transducer 1 according to the present invention is also larger than that of the headphone unit that vibrates the diaphragm, similarly to the vibration portion 150. However, the vibration portion 50 is held by the first end 10a and the second end 10b of the main frame 10 via the damper 60. Therefore, unintended vibration of the vibration portion 50 is suppressed, so that the electroacoustic transducer 1 is less likely to fail. Since the suspension 20 and the damper 60 having the elastic forces are interposed between the vibration portion 50 and the main frame 10, an amplitude (Q value) at the resonance point is effectively controlled. As a result, the present invention can implement the electroacoustic transducer 1 with high sound quality while suppressing unintended vibration even in a configuration using cartilage conduction in which the mass of the vibration portion 50 is larger than that of the headphone unit including the diaphragm.

### Frequency Response Characteristics of Electroacoustic Transducers 1 and 100

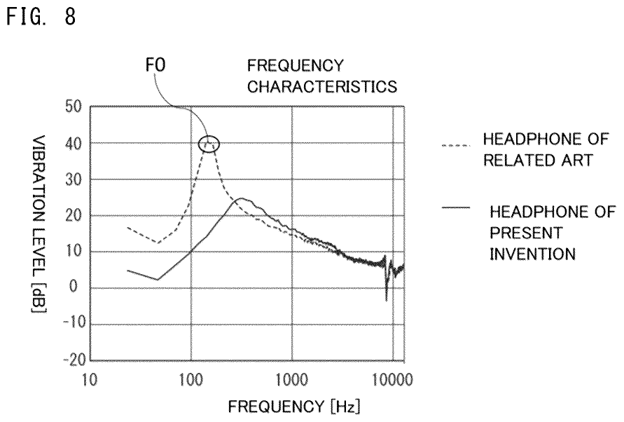

FIG. 8 illustrates a frequency characteristic of the headphone unit. That is, a horizontal axis represents a frequency, and a vertical axis represents an output level (dBV). A broken line indicates the frequency characteristic of the electroacoustic transducer 100 according to the related art, and a solid line indicates a frequency characteristic of the electroacoustic transducer 1 according to the present invention.

The electroacoustic transducer 100 according to the related art has a resonance point F0. A frequency of the resonance point F0 is determined by a relationship between a spring constant of the suspension 120 and a weight of the vibration portion 150 such as the magnet 153. As a result, the electroacoustic transducer 100 may give discomfort to the head of the wearer due to very large vibration generated at the frequency of the resonance point F0.

Since low-frequency resonance is damped by the damper 60, so that the frequency characteristic of the electroacoustic transducer 1 is smoother than the frequency characteristic of the electroacoustic transducer 100. That is, the electroacoustic transducer 1 can suppress unintended resonance and reduce discomfort given to the head.

### Electroacoustic Transducer (2)

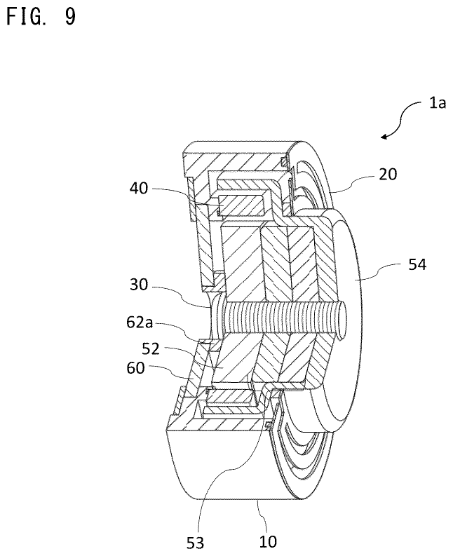

Here, second embodiment of the electroacoustic transducer of the present embodiment will be described focusing on portions different from the above-described embodiment. The same components as those of the first embodiment are denoted by the same reference numerals. An electroacoustic transducer 1a illustrated in FIG. 9 is different from the electroacoustic transducer 1 of the first embodiment in that a suspension 20 is not joined to a damper 60 and is fixed to an outer side of a cap yoke 54. The damper 60 is coupled to a center yoke 52 via an appropriate interposed member 62a. The presence or absence of the interposed member 62a is arbitrary. According to such a configuration, the suspension 20 is held at a position closer to the center of gravity of the electroacoustic transducer la as compared with the electroacoustic transducer 1 according to the first embodiment.

According to the embodiments described above, it is possible to provide a headphone that has a configuration for generating bone conduction vibration and ensures high sound quality by achieving a secure fit to the head regardless of individual differences.

Although the present invention has been described using the embodiments, the technical scope of the present invention is not limited to the scope described in the above embodiments, and various modifications and changes can be made within the scope of the gist of the present invention.

### REFERENCE SIGNS LIST

1 Electroacoustic Transducer
2 Housing
2a Outer Surface
2b Elastic Member
10 Main Frame
20 Suspension (First Member)
30 Screw
40 Coil
50 Vibration Portion
60 Damper (Second Member)
1000 Headphone (Audio Equipment)

1. Audio equipment comprising:
an electroacoustic transducer that generates vibration to be transmitted to a bone of a wearer;
a housing that houses the electroacoustic transducer; and
an elastic member disposed at least on an outer surface of the housing that faces the wearer in a worn state.

2. The audio equipment according to claim 1, wherein
the elastic member abuts on an ear cartilage of the wearer, and vibration of the electroacoustic transducer is transmitted to the ear cartilage via the elastic member.

3. The audio equipment according to claim 1, wherein
the elastic member abuts on a hard bone tissue of the wearer, and vibration of the electroacoustic transducer is transmitted to the hard bone tissue via the elastic member.

4. The audio equipment according to claim 1, wherein
the elastic member comes into close contact with irregularities of a body shape of the wearer without any gap.

5. The audio equipment according to claim 1, wherein
the elastic member is detachably disposed on the housing.

6. The audio equipment according to claim 1, further comprising
a housing holding portion that holds a pair of the housings, wherein
the pair of housings is held by the housing holding portion such that the outer surfaces of the pair of housings face each other, and
the housing holding portion presses the elastic member against the wearer in the worn state.

7. The audio equipment according to claim 1, further comprising
a housing holding portion that holds the housing, wherein
the housing holding portion presses the elastic member against the wearer by sandwiching an auricle of the wearer in the worn state.
